(19) United States
(12) Patent Application Publication
(10) Pub. No.: US 2019/0389753 A1
(43) Pub. Date: Dec. 26, 2019

(54) Biological treatment installation with sequencing batch reactor integrating purifying plants and moving biomass carriers, and method of implementation

(71) Applicant: Veolia Water Solutions and Technologies Support, Saint-Maurice (FR)

(72) Inventors: Abdelkader GAID, Paris (FR); Malik DJAFER, Boulogne Billancourt (FR)

(73) Assignee: Veolia Water Solutions and Technologies Support, Saint-Maurice (FR)

(21) Appl. No.: 16/483,778

(22) PCT Filed: Jan. 23, 2018
(86) PCT No.: PCT/EP2018/051564

§ 371 Date: Aug. 6, 2019

(30) Foreign Application Priority Data
Feb. 7, 2017 (FR) 1750997

(51) Int. Cl. C02F 3/12; C02F 3/32; C02F 3/08; C02F 3/20; C02F 3/30

(52) U.S. Cl. CPC C02F 3/1263; C02F 3/327; C02F 3/085; C02F 2101/16; C02F 3/302; C02F 3/308; C02F 2301/046; C02F 3/20

(57) ABSTRACT

Installation for the biological treatment of water comprising a sequencing batch reactor (SBR) characterized in that said sequencing batch reactor (1) receives purifying plants (2) provided with at least partially submerged roots (3) and moving hollow carriers (4) made of hard plastic on which a biomass grows.

### FIELD OF THE INVENTION

The invention relates to the field of water treatment, especially the treatment of wastewater in order to purify it.

More specifically, the invention relates to the field of water treatment in a sequencing batch reactor or SBR.

### PRIOR ART

Such sequencing batch reactors (SBRs) have been used for the treatment of wastewater since the beginning of the twentieth century. This type of reactor is used extensively throughout the world in order to treat both municipal and industrial wastewater. When the available space is limited, an SBR does indeed offer an opportunity to treat wastewater in a single reaction basin in which all the expected biochemical reactions take place, replacing the many basins that would carry out the same operation. This characteristic enables the building of wastewater treatment systems having a relatively small footprint. SBRs are therefore a variant of the classic method using activated sludges.

An SBR is typically implemented in four distinct steps: (1) filling the reactor, (2) biological reaction, (3) settling or decantation and (4) emptying or discharging.

During the filling step, the tank receives raw water which, in general, has undergone only pre-treatment, such as for example grit removal, de-oiling and degreasing. During this operation, the water can be stirred and/or aerated.

During the biological reaction phase, the bacterial biomass, through biochemical reactions, consumes the biodegradable organic carbon and the organic and mineral nitrogen (ammonia and nitrates) contained in the water. The input of oxygen into the reactor promotes the biochemical reactions of oxidation and the bacterial growth that results from these reactions. Intermittent cycles of aeration and non-aeration enable either the oxidation of the ammonia (aerated phase) or the reduction of the nitrates (non-aerated phase). The third step is the decantation (settling) phase during which the activated sludge is deposited at the bottom of the basin without any mechanical reaction.

Finally, during the last step, the reactor is drained of the treated water which is devoid of the essential part of the suspended matter that it had contained after the decantation step.

This water must then be clarified because it still contains a part of the biomass that has not decanted. The use of a clarifying device downstream from the SBR is therefore a conventional method. The use of this device increases the costs and the footprint of the installations.

At the same time, it is necessary to extract and treat excess sludge following its development during the biochemical reaction phases

Thus, during the settling (or decantation) step and the draining step, the SBR is not being fed with raw water to be treated. The SBR method therefore has a limited load capacity. Because of this, the raw water to be treated must be stored in a buffer basin situated upstream to the SBR. Very often, however, this buffer basin is not sufficient to store the entire flow of incoming water to be treated and therefore a second SBR line has to be installed. This second line then works in alternation with the first line and thus enables the continuous treatment of ail the raw influent that reaches the station.

There is therefore a need to resolve the problem of limited capacity of SBR methods and even to increase this capacity for existing SBRs instead of building new ones.

To this end, SBR type methods working with purifying plants have been developed. These purifying plants are most often integrated into a greenhouse, their roots being submerged in the reactor. According to such methods, such plants take part in the biological treatment of water as a complement to the activated sludge. These purifying plants also take part in the reduction of the odors in the treatment station. At present, there are numerous industrial models working according to this configuration.

The drawbacks related to the prior art are especially the following.

These techniques require the installation of a secondary clarifier to reduce the concentration of matter in suspension in the discharged effluent. Such a clarifier increases the footprint of the installation. In addition, its use in unfavorable conditions may lead to leakage of sludge. The sludge concentration in the biological basin must therefore be constantly controlled in order to keep this concentration at a high level.

Besides, in practice, it is difficult to obtain low concentrations of total nitrogen (TN or TKN) because of the denitrification conditions which are not simple to implement (recirculation of nitrified water, input of external sources of organic carbon etc.).

### Goals of the Invention

It is a goal of the present invention to propose an installation for the treatment of water in a sequencing batch reactor that does not have at least some of the drawbacks of the prior art referred to here above.

In particular, it is a goal of the invention to provide an installation for the treatment of water integrating a sequencing batch reactor having a smaller footprint than prior art installations, for equal performance and treatment capacity.

It is yet another goal of the present invention to propose an installation for the treatment of water that can do away with the need to implement a secondary clarifier to clarify the treated water extracted from this installation.

It is yet aother goal of the present invention to disclose a method for the treatment of water implementing such a plant in order to reduce its content in organic and mineral pollutants.

It is also a goal of the present invention to propose a method of this kind that does not include a step for the secondary clarification of treated water.

It is also a goal of the present invention to propose a method of this kind that optimizes the depollution of water.

### SUMMARY OF THE INVENTION

All or part of these goals are achieved according to the invention which relates to an installation for the biological treatment of water comprising a sequencing batch reactor (SBR) characterized in that said sequencing batch reactor receives purifying plants having roots that are at least partly submerged in said reactor and moving hollow carriers made of a hard plastic on which a biomass grows.

Thus, according to the invention, a biofilm is formed both on the roots, at least in the submerged part of the purifying plants, and on their moving hollow carriers,

Through the fixing of a part of the biomass to the moving hollow carriers and of another part to the roots, the quantity of free biomass is greatly reduced. The water obtained after the decantation phase therefore has a low particulate matter content. Thus, the installation according to the present invention does not need to include a secondary clarifier to treat the water extracted from the reactor after the decantation phase. The installation according to the invention therefore preferably does not include any secondary clarifier downstream from the sequencing batch reactor for the treatment of water extracted from the reactor at the end of the decantation phase. As a corollary, the installation according to the invention can therefore have a smaller footprint than prior art installations for equivalent treatment capacity and quality. In particular, it is less costly.

It will be noted that, according to the invention, the roots of the purifying plants of the sequencing batch reactor are at least partly submerged. Thus, their role in the biological treatment of water is optimized. On this subject, it will be noted that those skilled in the art would have been reluctant to provide moving carriers beneath such roots, for fear of damaging these roots and thus causing harm to this role.

In order to protect these roots, according to one variant of the invention, the sequencing batch reactor can be equipped with at least one screen to isolate said moving carriers from said at least partly submerged roots.

According to another variant of the invention, said moving carriers are isolated from said at least partly submerged roots by a section of still water. In practice, when the water to be treated is present in the reactor, a sheet of still water is provided between the lower end of the at least partly submerged roots of the purifying plants and the moving hollow carriers, so that, even when these carriers are put into motion, this motion does not put them in contact with the roots of the purifying plants. These roots and their functions are thus preserved.

The purifying plants used according to the invention could be chosen from among plants known to those skilled in the art and used in the context of water treatment. The species are chosen and adapted according to geographical areas characterized by conditions needed for their growth such as for example the humidity rate, the temperature etc. They could he constituted within one and the same reactor by a mixture of purifying plants of different species. A greenhouse will advantageously be provided above the reactor to protect these plants especially from low temperatures and temperature variations.

The term “moving hollow carrier” is understood to refer to independent elements, having a part of their surface protected from impacts and friction. Such impacts or friction can occur when the content of the reactor is stirred, during the filling phase or a biological treatment phase. Such elements are commercially available, especially from the firm AnoxKaldnes®.

The density of the material constituting these moving hollow carriers is such that when they receive a biofilm, they do not float but on the contrary descend to the bottom of the reactor. In practice, this density will be proximate to that of water.

According to one variant of the invention, the installation according to the invention comprises means for distributing ballast in said sequencing batch reactor. This feature enables the particulate matter not fixed to the moving carriers to be ballasted and thus favors its decantation. This ballast could be constituted by any material conventionally used in this context such as for example microsand. The decanted sludge extracted from the reactor could be treated so as to enable the recycling of this ballast.

According to one particularly promising variant of the invention, said sequencing batch reactor (SBR) has a first compartment receiving purifying plants and communicating with a second compartment receiving purifying plants, moving hollow carriers being provided in said second compartment.

According to one variant, said first compartment of said sequencing batch reactor (SBR) also receives moving biomass carriers made of plastic.

Equally advantageously, said sequencing batch reactor (SBR) comprises means for redirecting the water contained in said second compartment towards said first compartment.

The present invention also relates to a method for treating water in a sequencing batch reactor, said method comprising the steps of filling said reactor with water to be treated, carrying out the biological treatment of said water present in said reactor, decanting the biologically treated water in said reactor and discharging the treated water from said reactor, wherein said step of biological treatment is performed partly through a biomass growing on the at least partially submerged roots of purifying plants present in said reactor, and partly through a biomass growing on the moving hollow carriers present in said reactor.

Such a method could be implemented in a reactor according to the invention having one compartment. It then enables the treatment of the carbon pollution (BODS, COD) and, if necessary, denitrification by alternating aerated and non-aerated phases during the biological treatment phase.

According to one particularly promising variant, said sequencing batch reactor has a first compartment communicating with a second compartment, and said step of biological treatment is performed partly through a biomass growing on the at least partially submerged roots of purifying plants, present in said first compartment and in said second compartment, and partly through a biomass growing on moving hollow carriers present at least in said second compartment, said reactor including a step for redirecting the water contained in the second compartment towards said first compartment.

According to this particularly promising variant, said biological treatment comprises:
the reduction of a part of the carbon pollution, the denitrification and if necessary the dephosphatation of the water in said first compartment by placing the biomass that it contains alternately in aerobic and anoxic condition; and
   the nitrification and reduction of the carbon pollution of the water in the second compartment by placing the biomass that it contains in aerobic conditions.

It will be noted that, in such anoxic and anaerobic conditions, the quantities of oxygen discharged by the purifying plants do not disturb the kinetics of denitrification and, as the case may be, dephosphatation, these quantities being below the biochemical limits tolerated by the denitrification and dephosphatation bacteria.

According to one variant, said first compartment of said reactor does not contain moving hollow carriers.

According to one promising alternative, said first compartment of said sequencing batch reactor contains moving hollow carriers. According to such a variant, the size of the first compartment can be smaller, for equal performance and capacities and equal levels of treatment, than an installation in which the first compartment does not contain moving hollow carriers.

To prevent the moving carriers from damaging the roots of the purifying plants during said step of biological treatment, the moving hollow carriers are kept at a distance from said at least partially submerged roots of said purifying plants. According to one variant, said moving carriers are kept under controlled fluidization forming a section of still water without moving carriers, into which there extend said at least partially submerged roots of said purifying plants. In practice, such a section of still water could preferably have a thickness of 0.5 m to 2 m approximately.

According to another variant, said moving carriers are held at a distance from the at least partially submerged roots of the purifying plants by means of a screen.

According to one variant, the method additionally comprises a step for injecting a ballast into said sequencing batch reactor so as to ballast the particulate material that is not fixed to the carriers and accelerate its decantation.

### LIST OF FIGURES

The invention as well as its advantages will be understood more clearly from the following description of embodiments of this invention given with reference to the appended drawings of which:

FIG. 1 represents a schematic view of a first embodiment of an installation according to the present invention in which their SBR reactor has only one compartment;

FIG. 2 represents an example of moving carriers that can be used within the framework of the present invention;

FIG. 3 is a schematic view of a second embodiment of the invention in which the SBR reactor has only one compartment;

FIG. 4 is a schematic view of a third embodiment of the invention in which the SBR reactor has two compartments.

### DESCRIPTION OF EMBODIMENTS

Referring to FIG. 1, the installation according to the invention comprises a sequencing batch reactor (SBR) type of reactor surmounted by a greenhouse 6.

This reactor 1 has both purifying plants 2 and moving hollow carriers 4. The purifying plants are placed in an environment that enables them to be maintained and grow roots to reach the liquid medium, As indicated here above, these purifying plants 2 may consist of any plants known to those skilled in the art conventionally used in the context of water treatment. According to one essential characteristic of the invention, these purifying plants 3 have roots at least partially submerged 3 in water to be treated. These plants are protected from low temperatures and sudden variations in temperature by the greenhouse 6.

The purifying plants 2 cover the entire surface of the water present in the reactor 1 except for a part of this surface occupied by a device used to discharge water after the decantation phase. This device consist of a floating trough 7 linked to a pipe 8 for the discharging of the treated water.

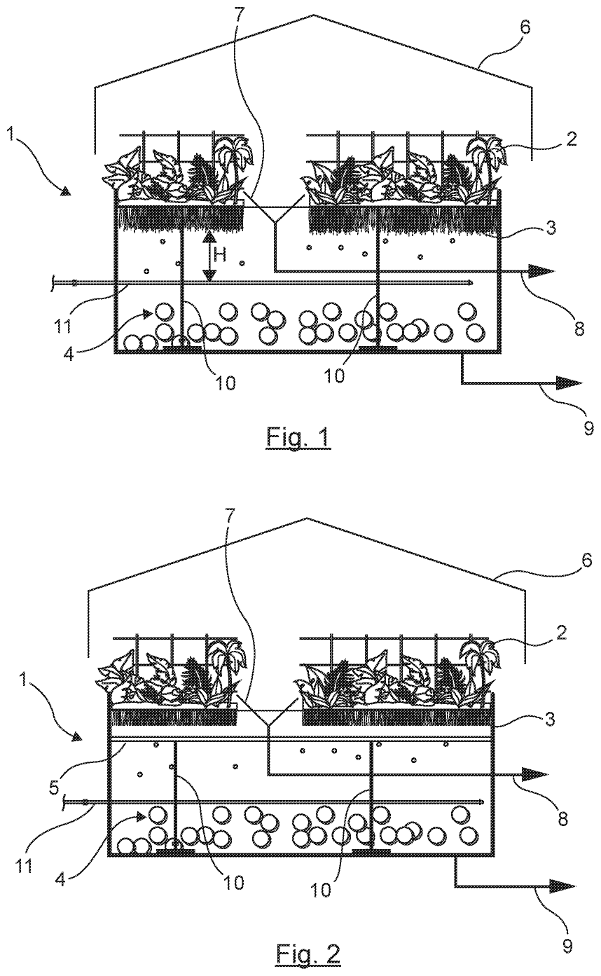

The moving hollow carriers 4 used within the framework of the present embodiment are carriers classically used in the commercially available moving bed biofilm reactors (MBBRs). A carrier of this type is shown in FIG. 2. These moving hollow carriers are made of hard plastic and have a density of 0.9 to 1.2. They have high void fraction and high specific surface. It can be noted that, in other embodiments, carriers of types other than those shown in FIG. 2 could be implemented, especially the K1, K3, K5 BiofilmChip™, BiofilmChip™ P or F3 type of carriers by AnoxKaldnes.

Optionally, the reactor 1 is also provided with mixing means 10 comprising blade-operated stirring devices and/or aeration means 11 including an aeration line. These different means enable the creation of aerobic, anoxic or anaerobic conditions in the water present in the reactor, depending on the desired biological treatment.

It can be also noted that the height of the reactor 1 is designed so as to prepare a section of still water with a height H that the moving carriers 4 do not penetrate when the mixing means 10 are actuated in order to fluidize the bed of moving hollow carriers 4. This height H of still water prevents any interaction that could damage these roots 3 between these carriers 4 and the roots 3 of the purifying plants 2 during this fluidizing process.

Means for draining the reactor 1 following the decantation step are planned. These means include a sludge-discharging pipe 9.

Finally, a screen (not shown) could be provided to prevent the carriers 4 from being taken along with the water extracted from the reactor.

Such an installation is meant to be implemented according to a sequencing batch method for treating said water. This method comprises steps for the filling of said reactor with water to be treated, the biological treatment of said water present in said reactor, the decantation of the biologically treated water in said reactor and the discharging of the treated water from said reactor.

According to the invention, the step of biological treatment is carried partly through a biofilm that grows on the at least partially submerged roots 3 of the purifying plants 2 and partly through a biofilm that grows on the moving hollow carriers 4.

With the biomass used for this step being thus fixed, the biologically treated water discharged by the floating trough 7 and the pipe 8 contain only very little solid matter so that no subsequent clarification of this water is needed.

After the step for decanting the water, the interstitial sludge present in the reactor is, for its part, discharged from the reactor 1 by the pipe 9.

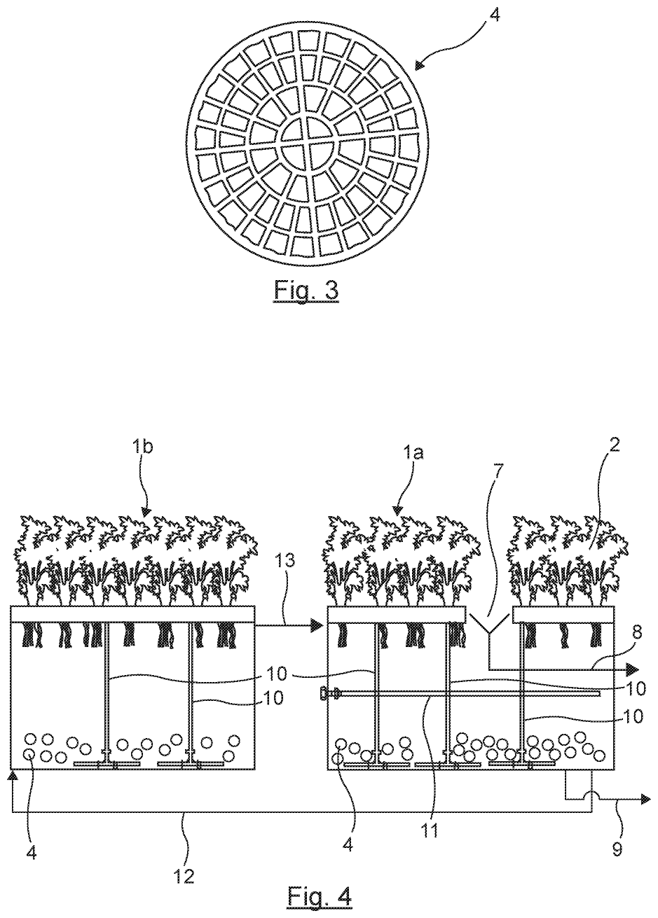

FIG. 3 represents another embodiment of an installation according to the invention. This installation does not differ from the one described in FIG. 1 except by the characteristic according to which a screen 5 is provided to isolate the moving carriers 4 from the at least partly submerged roots 3 of the purifying plants 2. This screen has a mesh that holds the moving carriers 4 in the lower part of the reactor 1 while allowing the water to pass through.

The installations shown in FIGS. 1 and 3 can be implemented to reduce carbon pollution and, as the case may be, ammonia nitrogen and phosphorous in the water by alternating aerobic, anoxic and anaerobic conditions during the biological treatment step, in practice by distributing or not distributing air through the aeration ramp 11.

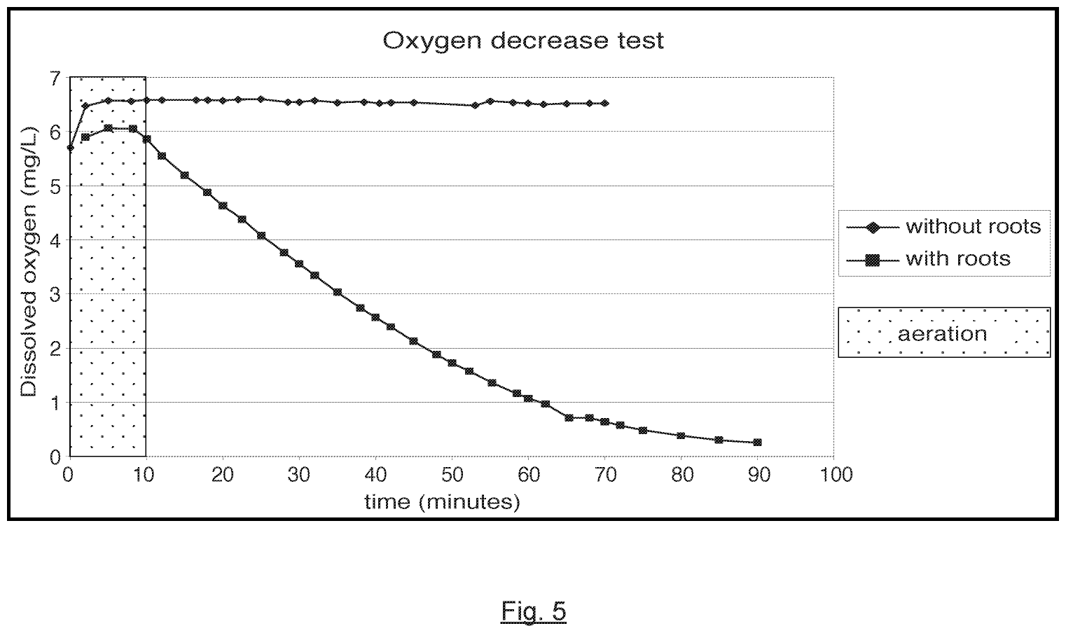

Referring to FIG. 4, a third embodiment of an installation according to the invention is shown.

According to this embodiment, said sequencing batch reactor comprises two compartments 1a, 1b communicating with each other by a pipe 13.

The second compartment 1b corresponds to a reactor 1 as described with reference to FIGS. 1 and 3.

The first compartment for its part comprises purifying plants 2 but does not comprise any aeration means.

Means for recycling the water from the first compartment to the second compartment are also planned. These means include a recycling pipe 12.

The purifying plants 2 used are essentially the same in the first and the second compartments.

Sieves (not shown) can be planned to prevent the carriers 4 from being driven along with the water extracted from the first and second compartments.

During the implementing of this installation, the reduction of a part of the carbon pollution, and the denitrification and, if necessary, the dephosphatation of the water is done in the first compartment 1a by placing the biomass that it contains alternately in anoxic and anaerobic conditions. The mixing means 10 of the first compartment 1b can then be implemented so as to fluidize the moving carriers in a controlled manner so that they do not penetrate the section of still water and therefore do not damage the roots 3 of the plants 2.

The nitrification and the reduction of carbon pollution in the water are done in the second compartment 1a by placing the biomass in aerobic conditions. A recycling of the water from the second compartment 1a to the first compartment 1b is carried out through the pipe 12.

The inventors have noted that in differential between the oxygen rejected by the plants in anoxic conditions and the oxygen rejected in anaerobic conditions does not disturb the kinetics of denitrification or dephosphatation, these kinetics being low as compared with the biochemical limits tolerated by the denitrification and dephosphatation bacteria.

In aerobic conditions, the oxygen discharged by the plants improves the conditions of growth of the biofilm because the oxygen gets diffused directly into the biofilm and becomes easily accessible to the bacteria.

Trials have been conducted on site in order to estimate the impact of the biofilm of the roots on the consumption of carbon and nitrogen pollution.

In these tests, the biological activity of the heterotrophic bacteria of the biofilm submerged in the raw water is verified, the biological activity being measured by oxygen consumption in the reaction medium.

According to these tests, the sampled roots are submerged in a 2-litre beaker filled with raw water. A dissolved-oxygen probe is introduced into the beaker and aeration and stirring means are used to stir and aerate the content of the beaker. Thus the oxygen decrease, which reveals bacterial activity, is measured.

The same protocol has been used to assess the effect of nitrification. While tracking the decrease in oxygen, NH₄ and NO_{3 are} also analyzed. In the same way as above, it is noted that the biomass fixed to the roots truly shows nitrification activity.

These results are synthesized in the graph according to FIG. 5 which indicates that the biofilm has biological activity (oxygen decrease linked to respiration of the biofilm).

The atmosphere in the greenhouse was also subjected to a study. Indeed, since the greenhouse was aerated only in the daytime when the climatic conditions (temperature and wind) allowed it, the atmosphere could then contain compounds such as ammonia (NH₃), hydrogen sulfide (H₂S) or again various mercaptans (sulfur compounds). The sensors for measuring NH₃, H₂S and mercaptans installed in the greenhouse indicated very low concentrations of these different compounds. A sample of air was then taken for analysis that was outsourced to a specialist laboratory. The parameters analyzed in this sampling were NH₃, H₂S, mercaptans. A gas analyzing unit was installed to track the concentration in oxygen and carbon dioxide for 39 hours, and the greenhouse was not aerated during this period. In the analyses of the odor-producing compounds, none of the compounds measured reached a concentration above quantification thresholds.

Trials were conducted to characterize the biomass present on the moving hollow carriers, found in the form of free biomass in the water in which the carriers are immersed, and the biomass fixed to the roots of the submerged plants.

These tests showed that:
the at least partly submerged biomass of the aerated, anoxic and anaerobic zones were similar in terms of composition in bacterial species to those found on the supporting media of the conventional type of moving bed biofilm (MBBR),
the biomass fixed to the roots of the plants was similar to that present on the moving hollow carriers.

1-17. (canceled)

18. A method of biologically treating water in a sequencing batch reactor, said method comprising filing said reactor with feedwater, biologically treating the water in the reactor, decanting the biologically treated water in the reactor and discharging treated water from the reactor; and
wherein biologically treating the water is performed partially through a biomass growing on at least partially submerged roots of purifying plants present in the reactor, and partly through biomass growing on moving biomass carriers present in the reactor.

19. The method of claim 18 wherein said sequencing batch reactor comprises a first compartment communicatively connected to a second compartment; and wherein biologically treating the water is performed partially through the biomass growing on the at least partially submerged roots of the purifying plants present in said first and second compartments, and partially through the biomass growing on the moving biomass carriers present in at least the second compartment; and wherein the method further includes recycling the water contained in the second compartment to the first compartment.

20. The method of claim 19 further including:
denitrifying the water in the first compartment by maintaining the water under alternating anoxic and anaerobic conditions;
transferring the denitrified water from the first compartment to the second compartment; and
nitrifying the water in the second compartment by maintaining aerobic conditions in the second compartment.

21. The method of claim 19 characterized in that said first compartment of the reactor does not contain moving biomass carriers.

22. The method of claim 19 characterized in that said first compartment contains moving biomass carriers.

23. The method of claim 18 wherein during biological treatment of the water, said moving biomass carriers are kept at a distance from the at least partially submerged roots of the purifying plants.

24. The method of claim 23 wherein during biological treatment, said moving biomass carriers are fluidized and form a section of still water that lies between the at least partially submerged roots and the biomass carriers; and wherein the still water does not include biomass carriers.

25. The method of claim 23 including employing a screen between the submerged roots and the biomass carriers and preventing the biomass carriers from contacting the submerged roots.

26. The method of claim 18 including injecting a ballast into the sequencing batch reactor.

27. A method of biologically treating water in a sequencing batch reactor, said method comprising filing said reactor with feedwater, biologically treating the water in the reactor, decanting the biologically treated water in the reactor and discharging treated water from the reactor; and
wherein biologically treating the water in the sequencing batch reactor comprises:
i. placing purifying plants having roots in the reactor;
ii. submerging the roots in the water to be treated in the reactor;
iii. growing biomass on the submerged roots and employing the biomass on the submerged roots to biologically treat the water;
iv. placing biomass carriers in the reactor and moving the biomass carriers through the water in the reactor and growing biomass on the biomass carriers that also biologically treats the water;
v. wherein both the biomass on the submerged roots and the biomass on the biomass carriers biologically treat the water; and
vi. protecting the roots by isolating the biomass carriers from the submerged roots in the reactor and preventing the biomass carriers from contacting the submerged roots of the purifying plants.

28. The method of claim 27 wherein protecting the submerged roots includes forming a layer of still water between the submerged roots and the biomass carriers.

29. The method of claim 27 including separating the submerged roots from the biomass carriers by a screen that extends transversely across the reactor and which provides a division between the submerged roots that lie on one side of the screen and the biomass carriers that lie on the other side of the screen, thereby preventing the biomass carriers from contacting the submerged roots of the purifying plants.

30. The method of claim 27 wherein the treated water is not subjected to secondary clarification as the employment of biomass on both the submerged roots and the biomass carriers reduce or minimize the particulate matter content of the treated water.

31. The method of claim 27 wherein said sequencing batch reactor comprises first and second compartments and wherein the submerged roots are contained in both said first and second compartments and wherein the biomass carriers are contained in the second compartment; and wherein the method includes recycling at least a portion of the water from the second compartment to the first compartment.

32. The method of claim 31 wherein biologically treating the water comprises:
denitrifying the water in the first compartment by maintaining alternating anoxic and anaerobic conditions in the first compartment; and
nitrifying the water in the second compartment by maintaining aerobic conditions in the second compartment.

33. The method of claim 28 characterized in that said first compartment of the sequencing batch reactor does not contain moving biomass carriers.

34. A system for biologically treating water comprising:
a sequencing batch reactor having at least one compartment and configured to receive water;
purified plants having roots contained in the reactor;
wherein the roots project into the water and grow biomass thereon and wherein the biomass on the roots contributes to biologically treating the water; and
an array of moving biomass carriers contained in the reactor and configured to grow biomass thereon.

35. The system of claim 34 wherein the reactor is configured to isolate the submerged roots from the moving biomass carriers and to prevent the biomass carriers from contacting the submerged roots of the purified plants.

36. The system of claim 34 wherein there is provided a layer of still water that lies between the submerged roots and the moving biomass carriers; and wherein the layer of still water does not include biomass carriers.

37. The system of claim 34 including a screen extending horizontally across the reactor and wherein the submerged roots lie on one side of the screen and the biomass carriers lie on the other side of the screen, thereby preventing the biomass carriers from contacting the submerged roots.

38. The system of claim 34 including a greenhouse overlying at least a portion of the sequencing batch reactor and configured to protect the purifying plants.

39. The system of claim 34 wherein the sequencing batch reactor includes first and second compartments; and wherein there is provided purifying plants in both the first and second compartments; and wherein the moving biomass carriers are also contained in one compartment.

40. The system of claim 39 wherein there is provided a recycle line for recycling water from the second compartment to the first compartment.
